(19) United States
(12) Patent Application Publication
(10) Pub. No.: US 2025/0292695 A1
(43) Pub. Date: Sep. 18, 2025

(54) Evaluating the Performance of a Conversation in Real-Time and Coaching the Person Leading the Conversation to Perform More Effectively

(71) Applicants: David Philip FRANKLE, Los Gatos, CA (US); Laura Jean TEMPLIN, Reno, NV (US)

(72) Inventors: David Philip FRANKLE, Los Gatos, CA (US); Laura Jean TEMPLIN, Reno, NV (US)

(21) Appl. No.: 19/077,201

(22) Filed: Mar. 12, 2025

Related U.S. Application Data
(60) Provisional application No. 63/564,633, filed on Mar. 13, 2024.

(51) Int. Cl. G09B 5/02; G06F 40/35; G06Q 50/20

(52) U.S. Cl. CPC G09B 5/02; G06F 40/35; G06Q 50/2057

(57) ABSTRACT

A system and method are provided for evaluating the performance of an ongoing conversation in real time and delivering dynamic coaching to the interviewer. The system collects multi-modal data—including audio, video, and contextual information such as psychographic profiles and company data—and processes this input through speech-to-text conversion, speaker diarization, and sentiment, facial expression, and body language analysis. A performance score is dynamically computed and adjusted based on conversation statistics, mute and camera status, and confusion metrics. Based on this continuously updated score, the system delivers real-time, data-driven coaching suggestions to help the interviewer refine their communication techniques and achieve predefined conversational goals. This approach enhances engagement and objectivity in high-stakes interactions, such as job interviews, sales calls, and negotiations.

### BACKGROUND OF THE INVENTION

Conversations are a fundamental building block of human interaction, shaping relationships, decisions, and outcomes across personal and professional domains. In many contexts, one individual actively guides the conversation to achieve specific goals, whether it's gathering critical information, negotiating a complex agreement, evaluating a job candidate, closing a sale, etc.

Current methods for evaluating the effectiveness of these conversations often suffer from several key drawbacks:

Delayed Feedback: Reviews occur after the conversation, missing the opportunity to make in-the-moment adjustments, limiting the impact of improvement efforts.

Subjectivity: Evaluations can be heavily influenced by personal biases or limited recall of the interaction, hindering accurate skill assessment.

Resource-Intensive: Manual analysis or in-depth reviews by experts can be time consuming and costly, making them impractical for frequent use.

Limited Tools Available: The vast majority of tools available today provide value after the conversation, which faces the same delayed feedback issues presented by manual feedback.

### SUMMARY OF THE INVENTION

The invention provides a system and method for evaluating an ongoing conversation in real time and for offering immediate coaching to the person leading the conversation (the “interviewer”). The system works as follows:

### Real-Time Evaluation:

The system first gathers information about the conversation participants by using data such as their psychographic profiles, demographic details, job titles, or company information. It converts speech to text and identifies which party is speaking. Based on the text and the tone of the conversation, the system assigns a performance score that reflects how well the conversation is proceeding.

### Dynamic Score Adjustment:

The initial score is then modulated by analyzing additional cues:

Visual Cues: Video analysis is used to detect facial expressions and body language. Positive cues boost the performance score, while negative cues lower it.

Additional Metrics: The system also tracks whether participants are muted or have their cameras turned off, monitors the discussion of pre-defined goals, and calculates conversation statistics (such as the ratio of speaking time, number of questions, and interruptions). It further computes a confusion score by evaluating instances of confusion versus engagement, which then adjusts the overall performance score accordingly.

### Real-Time Coaching:

Based on the evolving performance evaluation, the system provides targeted, real-time coaching to the interviewer. For example, it can suggest alternative phrasing for questions, offer hints or reminders drawn from a relevant corpus of documents (like company manuals or sales scripts), or even propose answers if the interviewer is unsure how to respond.

### Objective, Immediate Feedback:

By delivering this immediate, data-driven feedback, the system enables interviewers to refine their communication techniques during the conversation, helping them build better rapport, maintain engagement, and address misunderstandings as they occur.

Overall, the invention empowers interviewers across various domains—such as job interviews, sales calls, legal depositions, and high-stakes negotiations—by transforming live conversational data into actionable insights and coaching, thus enhancing performance and reducing the impact of delayed or subjective feedback.

### Advantages of the Invention

Real-time coaching has the potential to revolutionize how individuals leading conversations develop their skills. By providing immediate and objective feedback, this approach can:

Accelerate Learning: Interviewers can instantly identify and address areas for improvement, leading to faster skill development compared to delayed evaluations.

Situational Adaptability: Feedback tailored to the specific moment offers interviewers guidance to navigate unexpected turns and optimize their approach within the flow of the conversation.

Data-Driven Guidance: Coaching based on objective analysis eliminates biases and provides concrete, actionable insights for skill enhancement.

### BRIEF DESCRIPTION OF DRAWINGS

FIG. 1 shows how the interviewer sets the meeting goals and success criteria and how these inputs are stored in the database via internal server operations.

FIG. 2 shows the generation of a baseline weighted calculation for the Read the Room score prior to the meeting, mapping personality, culture, and tracked actions to pre-assigned scores.

FIG. 3 shows the detection and scoring of sentiment during the meeting-capturing audio via a microphone, processing the sentiment, and comparing it with facial expression data.

FIG. 4 shows the detection and evaluation of facial expressions during the meeting, including counting positive, negative, or confused expressions and adjusting the confusion score accordingly.

FIG. 5 shows the detection and scoring of body language during the meeting, with the system analyzing video data to determine the impact on the overall confusion score.

FIG. 6 shows the analysis of meeting actions, including speaker identification, mute and camera status, and the tracking of goal progress, all contributing to the final Read the Room score.

FIG. 7 shows the conversion of conversation audio into text and the calculation of conversation statistics such as speaking time, questions asked, interruptions, and speaking speed.

FIG. 8 shows the real-time generation of the Read the Room score, where the algorithm fetches and weights scores from various inputs every 0.5 seconds during the meeting.

FIG. 9 shows the adjustment of the final Read the Room score at meeting's end based on actions like microphone muting, camera usage, and other performance criteria.

FIG. 10 shows the adjustment of the final score based on whether a meeting goal was set and achieved, updating the score accordingly.

FIG. 11 shows the recalculation of the final Read the Room score using the cumulative confusion score derived from facial expression and body language analyses.

FIG. 12 shows the system for displaying real-time hints to the interviewer-using the current Read the Room score to select and present appropriate suggestions and reordering talking points if needed.

FIG. 13 shows the prefetching process for relevant information ahead of a meeting, including reviewing the database, prompting the LLM, and crawling the web for topics of interest.

FIG. 14 shows how an interviewee-specific call plan or agenda is generated by mapping interviewee data (such as company profile and public information) and saving the resulting plan.

FIG. 15 shows the data aggregation and accuracy/ranking algorithm that merges inputs from various data systems into a vector database to display relevant information hints in real time.

FIG. 16 shows a base call plan template for sales conversations, generated when a new user is identified and company information is provided.

FIG. 17 shows how the system fetches specific information about a deal or conversation topic by linking to external systems and crawling for data such as revenue, employee count, and competitors.

FIG. 18 shows the real-time detection and transcription of questions and answers during a call, with question statuses updated and stored.

FIG. 19 shows the generation of post-meeting summaries and the creation of next-meeting plans based on transcription data and AI-generated follow-up talking points.

FIG. 20 shows the user interface for the system, depicted as a sidebar adjacent to video conferencing windows in the software embodiment.

FIG. 21 shows additional user interface details that support the display of real-time performance data and coaching suggestions.

FIG. 22 is a block diagram illustrating the overall system architecture comprising UI, Coaching, Conversation-Analytics, Empathy, Processing, and Data-Collection modules.

### DETAILED DESCRIPTION

The present invention provides a system and method for analyzing conversations in real time and providing dynamic coaching to the interviewer. The system comprises several key components that work in concert: a Data Collection Module, a Preprocessing Module, a Conversation Analysis Module, an Empathy AI Module, and a Coaching Module. Diagram 22 illustrates the interactions among these modules. Two distinct user interfaces are provided—one for general data display (UI Module 01) and one dedicated to delivering real-time coaching feedback (Coaching Module 02). Information is initially gathered in the Data Capture Module (10), processed (09), and then routed into the Conversation Analysis Module (05) and/or the Empathy AI Module (07) to rank, sort, and present data that enables optimal conversational outcomes.

### Overall System Architecture

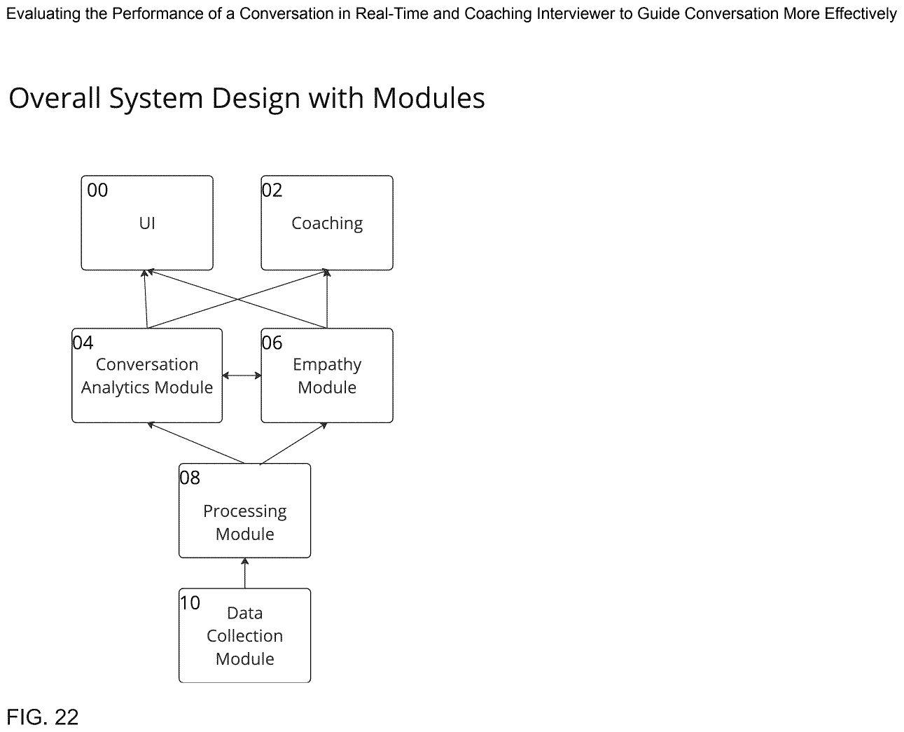

The system comprises several key components that work together to analyze conversations in real time and provide coaching to the interviewer. These components include a Data Collection Module, a Preprocessing Module, a Conversation Analysis Module, an Empathy AI Module, and a Coaching Module. FIG. 22 illustrates the interactions among these modules. Two distinct user interfaces are provided-one for general data display (2200) and one for delivering real-time coaching feedback (2202). Information is initially gathered in the Data Capture Module (2210), processed (2208), and then routed into the Conversation Analysis Module (2204) and/or the Empathy AI Module (2206) to rank, sort, and present data that helps users prepare for and navigate conversations for optimal outcomes.

In one embodiment, the Data Collection Module is responsible for capturing audio, optional video, and other relevant data streams during a conversation. This module also enables the interviewer to input meeting goals and success criteria, which are stored in the database. Data collection is facilitated through direct access to the interviewer's microphone, via API connections to video conferencing or VoIP systems, or through real-time streaming for in-person embodiments. Additionally, the module aggregates external contextual information about the interviewee from public profiles and data providers.

The Preprocessing Module performs essential tasks such as noise reduction, speech-to-text conversion (using technologies such as OpenAI's Whisper or Google Cloud Speech-to-Text), speaker diarization to identify and distinguish conversation participants, and text normalization. The output of this module is a clean transcript that serves as input to the Conversation Analysis Module.

The Conversation Analysis Module is the core analytical engine. It identifies the type of conversation based on either user input or predetermined scenarios and cross-references the conversation data against a relevant knowledge base. It computes key metrics—including speaking time proportions, the number of questions asked, and interruption counts—and assigns a performance score that reflects how well the conversation meets the predefined success criteria.

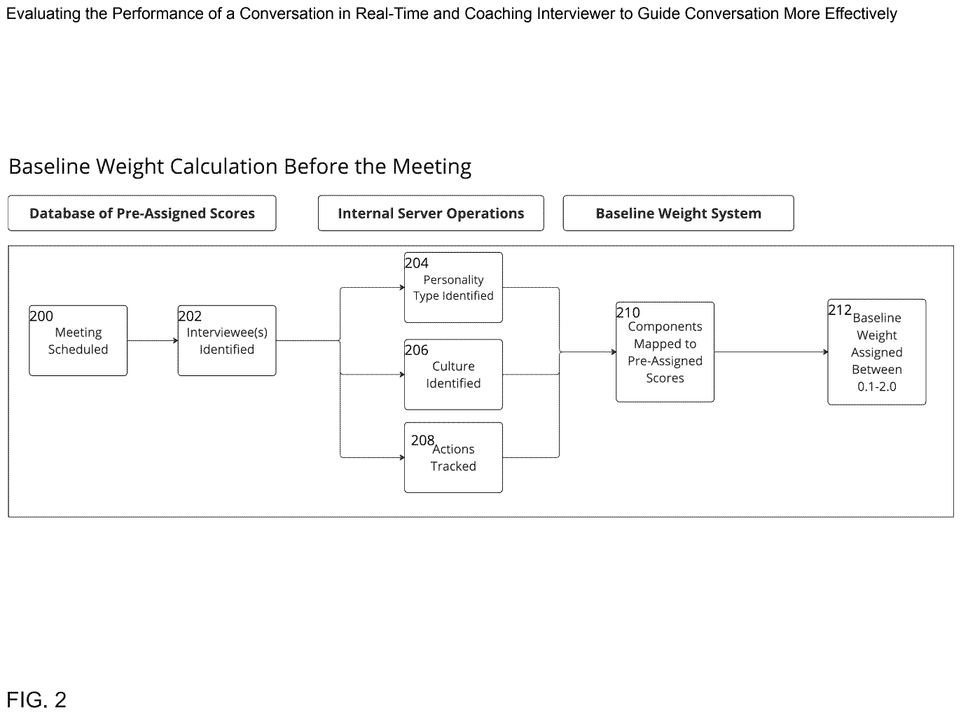

The Empathy AI Module evaluates the emotional state and engagement level of the conversation participants. This module integrates several sub-components, such as sentiment analysis, facial expression analysis, and body language analysis, as well as assessments based on the interviewee's psychographic and cultural profiles. The module computes a “Read the Room” score that dynamically reflects the overall emotional quality and engagement of the conversation. For example, the baseline weighted calculation (illustrated in FIG. 2) factors in personality, culture, and prior actions to establish a starting point for the score.

The Coaching Module leverages outputs from both the Conversation Analysis and Empathy AI Modules to generate real-time, context-specific coaching suggestions. These suggestions may include rephrasing a question if confusion is detected, offering hints from a relevant data corpus, or recommending strategies to re-engage the conversation partner if their interest wanes. The module continuously adapts its feedback as new conversational data is received.

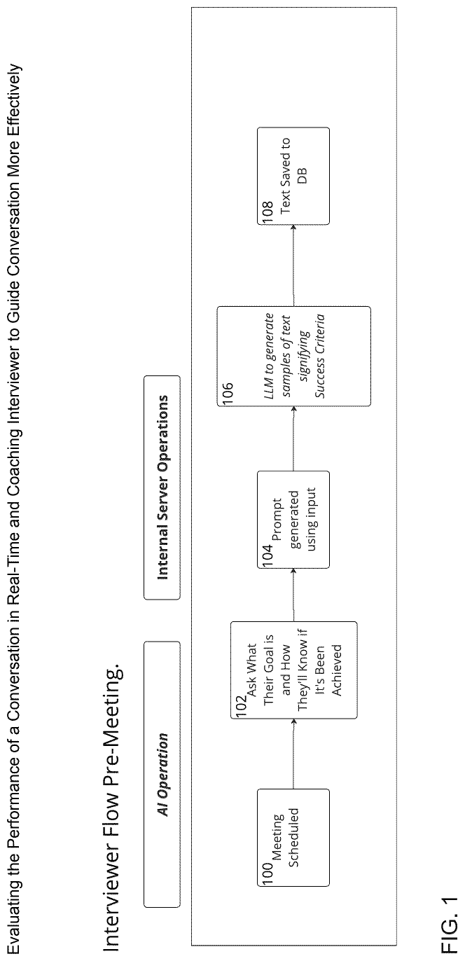

FIGS. 1-12 detail the Empathy AI module and the Read the Room score algorithm. (The full Read the Room score algorithm is described in detail in the Appendix.) For instance, FIG. 1 shows how the interviewer's goals and success criteria are set and stored in the database. The internal server identifies when a meeting is scheduled (100) and retrieves these criteria (102), then uses the input to create a prompt (104) for the LLM, which generates sample text indicative of success criteria (106) that is subsequently saved (108).

FIG. 2 illustrates the generation of a baseline weighted calculation for the Read the Room score prior to the meeting. When a meeting is scheduled (200), the system identifies the interviewees using a Baseline Weight system (202) and captures parameters such as personality (204), culture (206), and tracked actions (208). Each parameter is mapped to pre-assigned scores stored in the database (210), and the internal server adjusts the baseline weighted average accordingly (212).

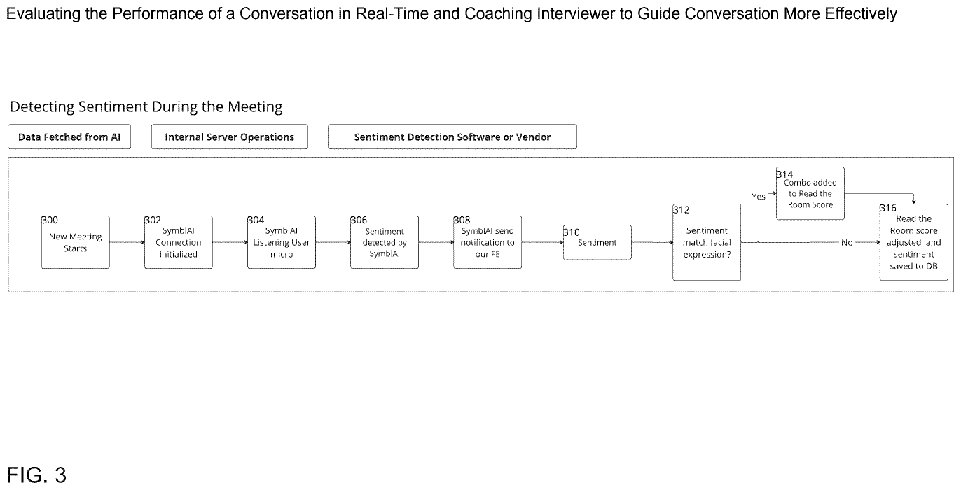

FIG. 3 details the detection and scoring of sentiment during the meeting. At the meeting's start (300), the internal server initializes sentiment detection software (302) and begins capturing audio (304) to detect sentiment (306). The sentiment vendor transmits the detected sentiment data to the Nayak Front End (308), and this data is compared with facial expression inputs fetched from AI (312). If the sentiment and facial expression data match (314), the combined information is added to the Read the Room score (314) and saved (316); if they do not match, the score is adjusted accordingly (316).

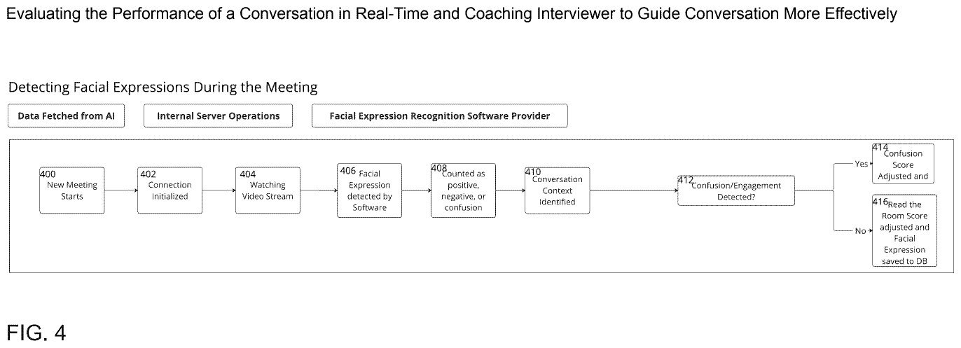

FIG. 4 shows the detection and evaluation of facial expressions during the meeting. When the meeting commences (400), facial expression recognition software is initialized (402) and the video stream is analyzed (404) to detect facial expressions (406). Each detected expression is classified as positive, negative, or confused (408). AI assesses the context in which the expression occurred (410) and determines whether confusion is present (412). If confusion is detected, the internal server adjusts the confusion score (414) and updates the Read the Room score (416).

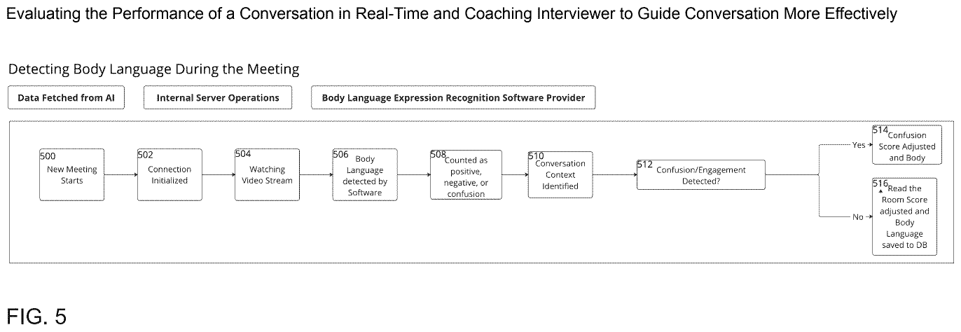

FIG. 5 depicts the detection and scoring of body language during the meeting. At the beginning (500), the system initializes body language recognition software (502) and analyzes the video stream (504) to detect body language cues (506). These cues are classified as positive, negative, or confused (508). AI evaluates the context (510) and, if the cues indicate confusion (512), the system adjusts the confusion score (514) and updates the overall score (516).

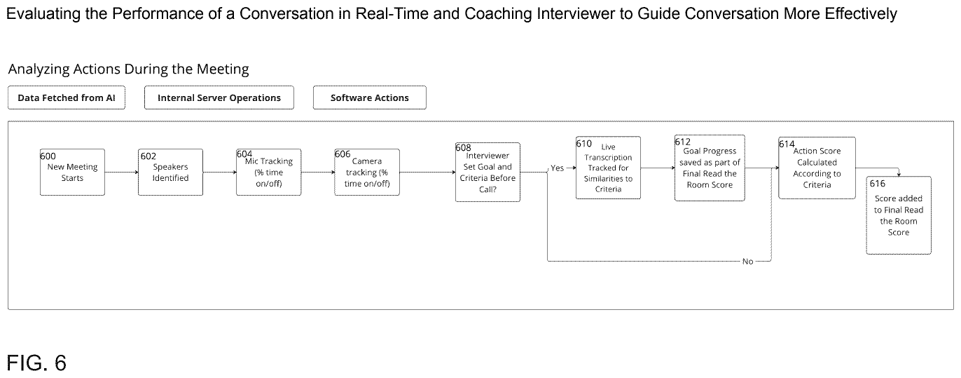

FIG. 6 shows how meeting actions are analyzed. When a meeting starts (600), the internal server identifies speakers (602) and tracks whether the microphone is active or muted (604) and whether the camera is on or off (606). It retrieves the predefined goals (608) and monitors the live transcript for progress (610). The server saves the goal progress as part of the final Read the Room score (612) and calculates an action score based on specific criteria (614), which is then added to the final score (616).

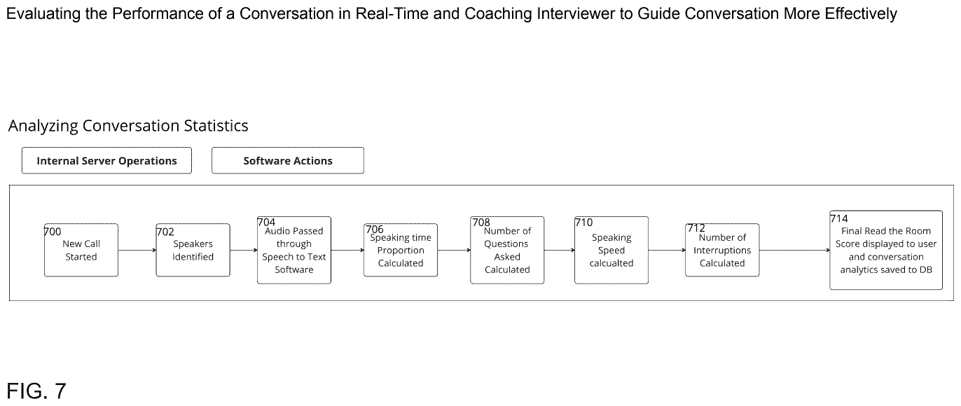

FIG. 7 describes how conversation statistics are generated. At meeting initiation (700), the system identifies speakers (702) and converts speech to text (704). It then calculates metrics such as speaking time proportion (706), the number of questions asked (708), speaking speed (710), and interruptions (712). These metrics are stored (714) and used to update the final Read the Room score.

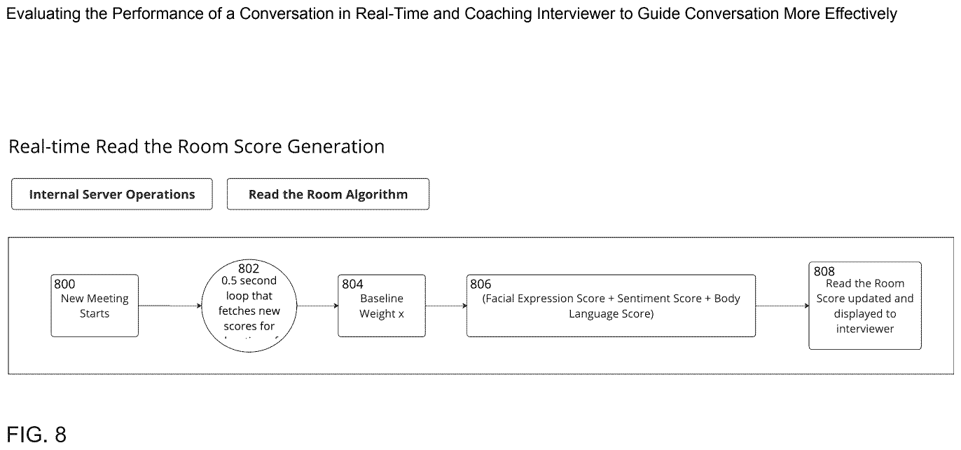

FIG. 8 shows the real-time generation of the Read the Room score during a meeting. The internal server fetches the current score every 0.5 seconds (802), and the algorithm combines the baseline with inputs from facial expressions, sentiment, and body language (804, 806) to update and display the score (808).

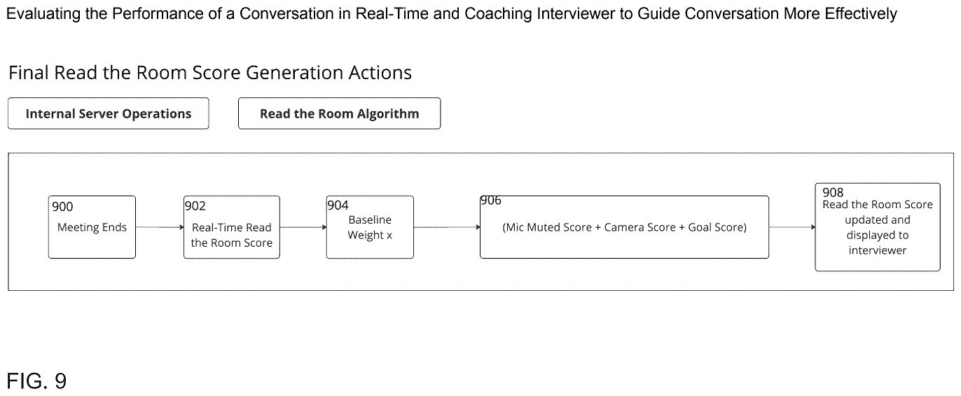

FIG. 9 illustrates the adjustment of the final Read the Room score at the meeting's end. When the meeting concludes (900), the algorithm takes the real-time score (902) and re-weights it using additional factors such as microphone muting, camera usage, and goal achievement (904) to compute the final score (908), which is then presented to the user.

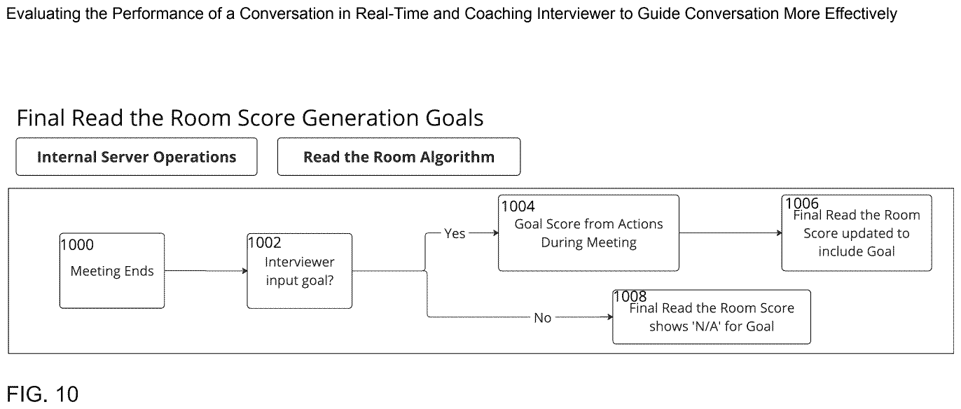

FIG. 10 details the adjustment of the final score based on meeting goals. At the meeting's conclusion (1000), the system checks if a goal was set by the interviewer (1002). If a goal exists, it calculates a goal score (1004) and updates the final Read the Room score (1006); if no goal is set, the score is indicated as “N/A for Goal” (1008).

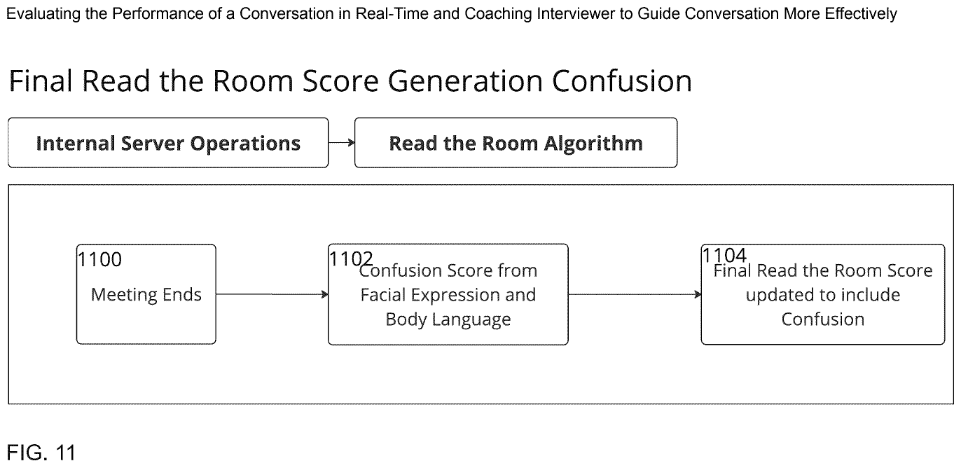

FIG. 11 shows how the final score is further refined by incorporating the cumulative confusion score. At meeting end (1100), the algorithm retrieves the overall confusion score derived from facial expression and body language analysis (1102) and updates the final score accordingly (1104).

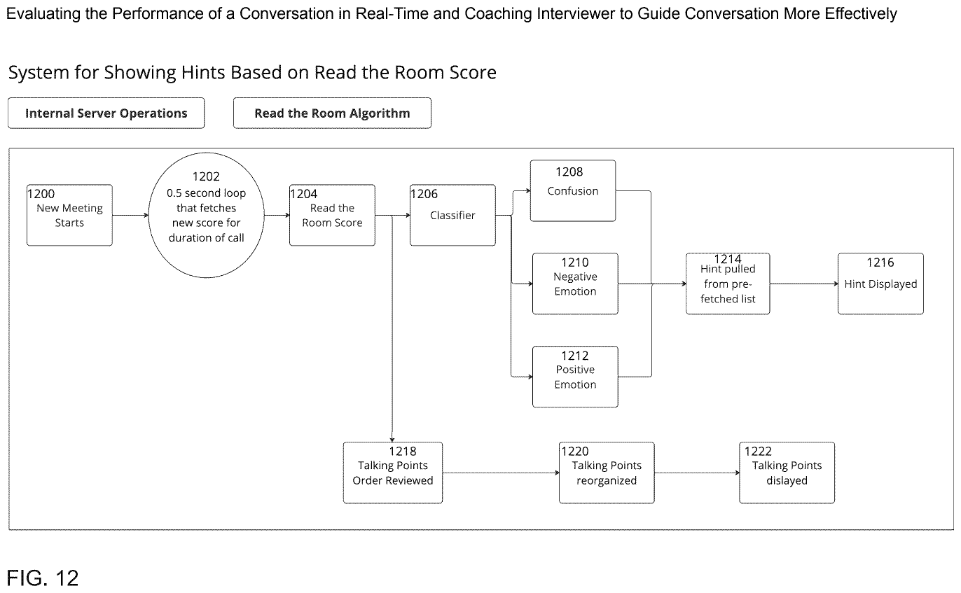

FIG. 12 depicts the system for delivering real-time coaching hints to the interviewer. As the meeting begins (1200), the internal server retrieves the current Read the Room score every 0.5 seconds (1202) and determines the appropriate classification based on the score (1204, 1206, 1208, 1210, 1212). A corresponding hint is then selected (1214) and displayed (1216), while the algorithm also reorders talking points as necessary (1218, 1220) before final display (1222).

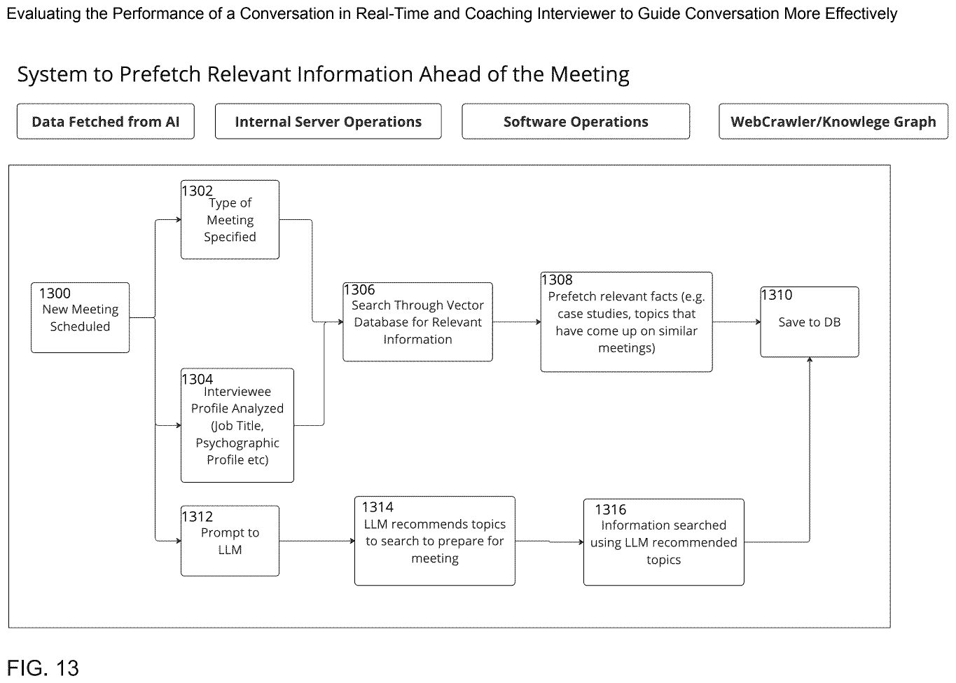

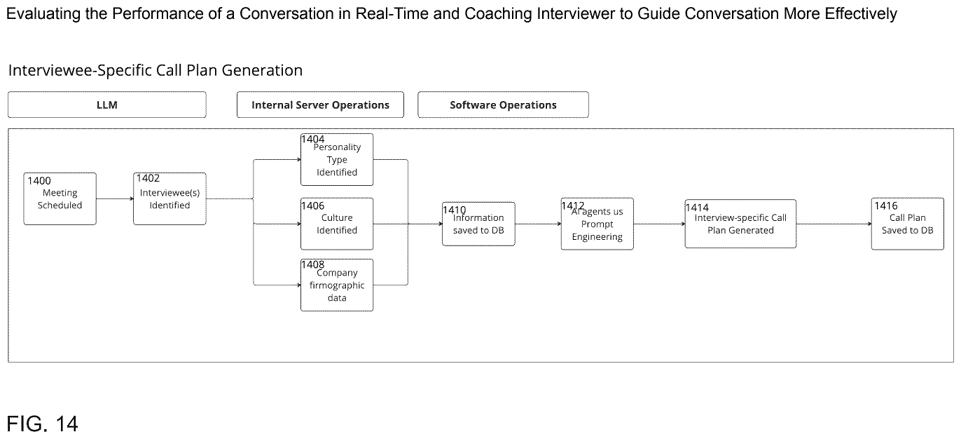

FIGS. 13 and 14 address pre-meeting preparation. FIG. 13 shows the process of prefetching relevant information from the company database and external sources using an LLM to suggest meeting topics. When a new meeting is scheduled (1300), the system identifies the meeting type (1302) and the interviewee profile (1304), reviews the database for context (1306, 1308), and prefetches information, which is stored (1310). Simultaneously, the LLM is prompted to recommend topics (1312, 1314) and crawls the web for additional data (1316). FIG. 14 demonstrates how an interviewee-specific call plan is generated by mapping the interviewee's firmographic data and public profile (1400, 1402, 1404, 1406, 1408) and saving the resulting plan (1410, 1412, 1414, 1416).

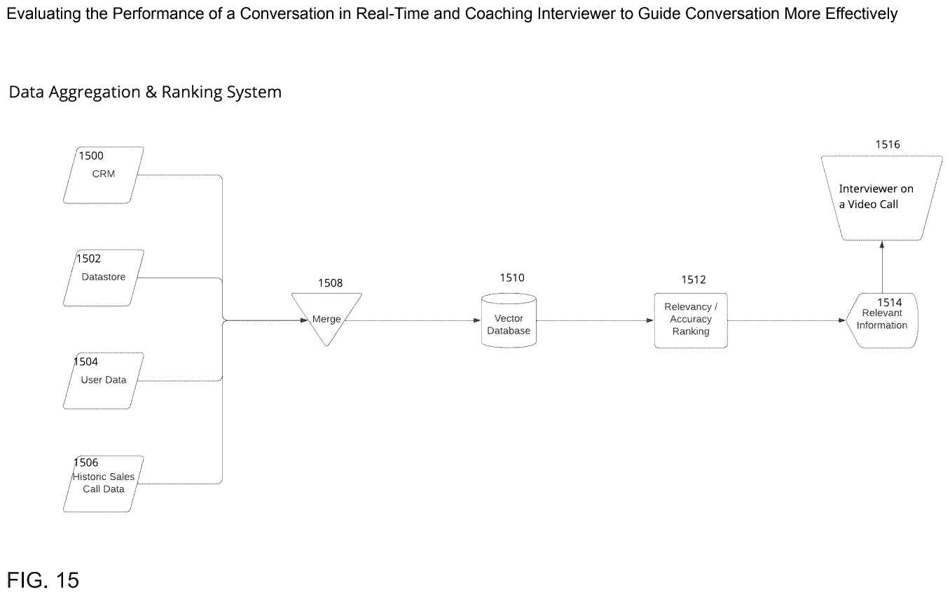

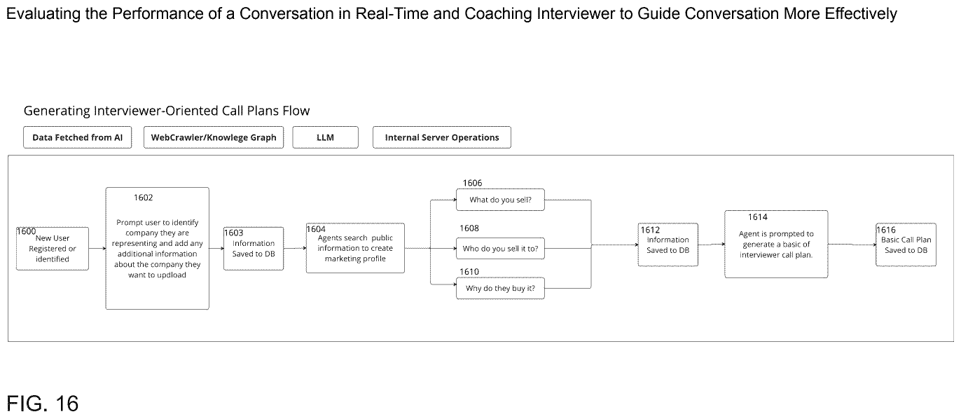

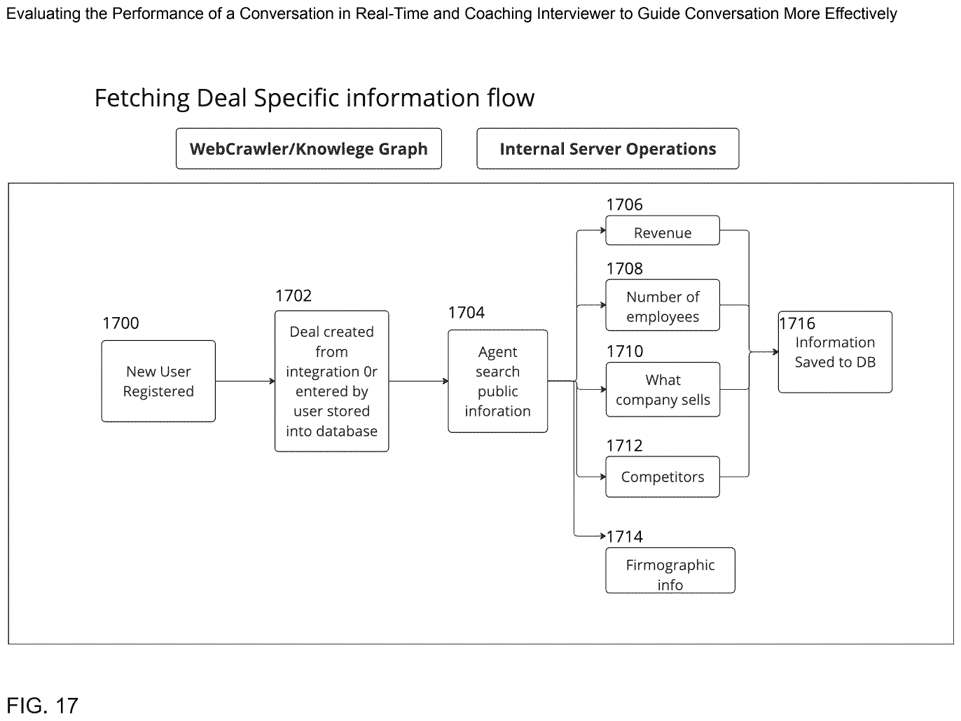

FIGS. 15-17 provide additional functionalities. FIG. 15 illustrates the data aggregation and accuracy/ranking algorithm that merges information from various sources into a vector database (1500-1512). FIG. 16 shows a base call plan template for sales conversations; when a new user is identified (1600), the system prompts for company data (1602) and aggregates public data to create a marketing profile (1603, 1604, 1606, 1608, 1610), resulting in an agent-generated call plan (1614, 1616). FIG. 17 demonstrates how the system fetches specific information about a deal or conversation topic by linking with external data sources (1700, 1702) and crawling for details such as revenue, employee count, and competitors (1704, 1706, 1708, 1710, 1712, 1716).

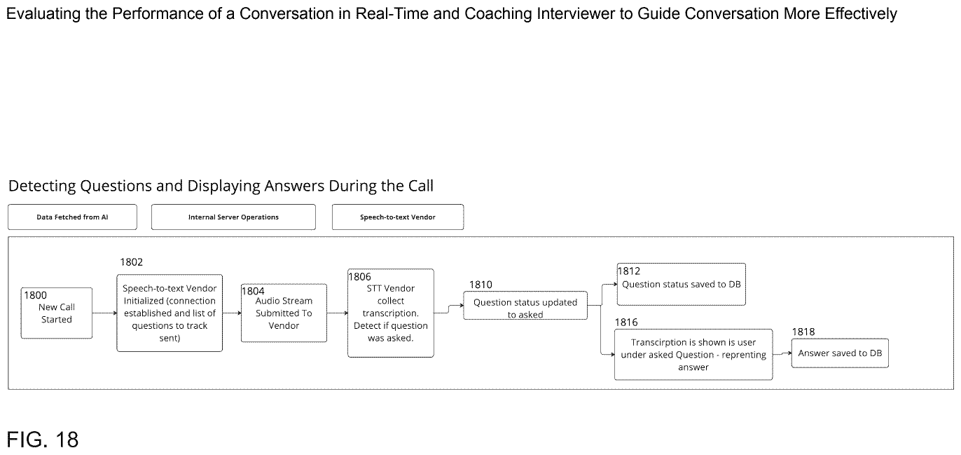

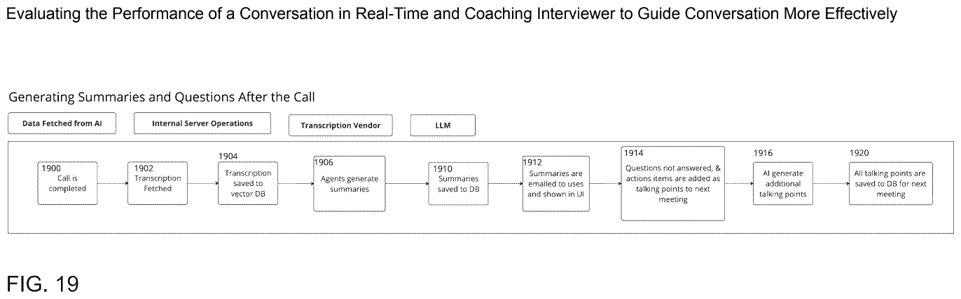

FIGS. 18 and 19 describe real-time interaction adjustments and post-meeting follow-up. FIG. 18 shows how the system detects and transcribes questions and answers during a call; when a call starts (1800), speech is converted to text (1802, 1804), and upon detecting a question (1806), its status is updated (1810) and stored (1812); corresponding answers are transcribed, displayed (1816), and saved (1818). FIG. 19 illustrates the generation of meeting summaries and next meeting plans; when a call ends (1900), the transcription is fetched (1902) and stored (1904), after which multiple agents generate summaries (1906, 1910) that are delivered via email and the user interface (1912), with unanswered questions and action items saved for future meetings (1914, 1916, 1918).

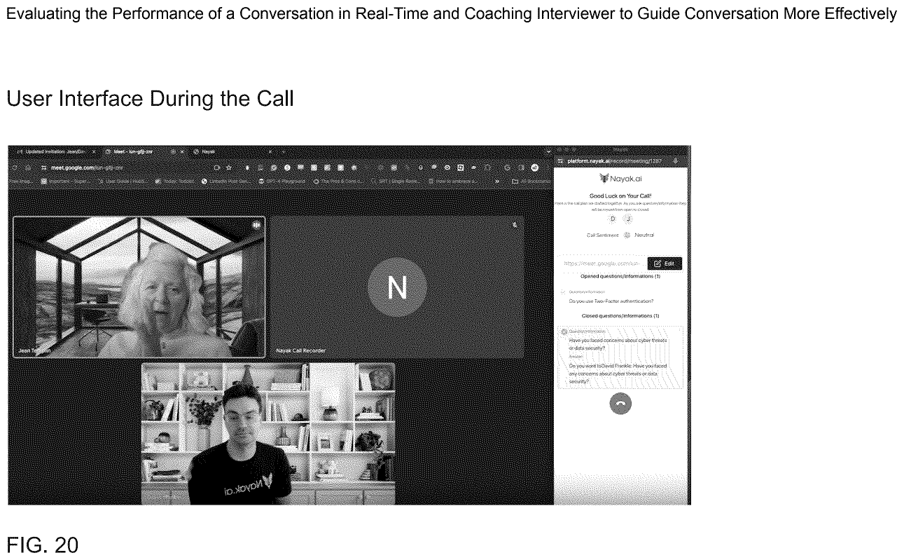

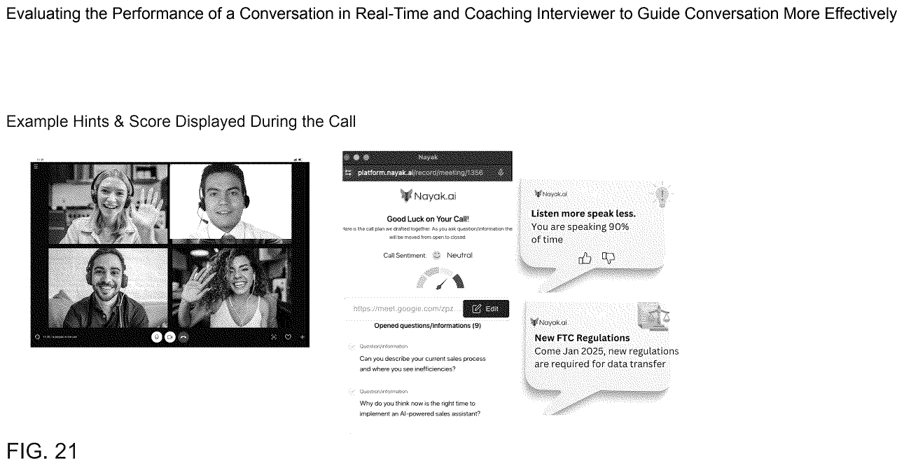

FIGS. 20 and 21 depict the user interface. FIG. 20 shows a sidebar integrated with video conferencing windows that displays the live Read the Room score and real-time coaching suggestions, while FIG. 21 provides additional details on interactive elements and overall presentation of performance data.

The system further incorporates various subprocesses for data capture, real-time analysis, and post-meeting processing. The Data Collection Module connects to audio and video streams using vendors such as Recall.ai and aggregates external data via web crawling. The Preprocessing Module cleans and converts this data, while the Conversation Analysis Module employs Nayak's Relevancy and Accuracy Ranking algorithm to process and present live conversation data. Post-meeting, the system compiles performance metrics—including microphone and camera usage, goal achievement, and engagement statistics—to generate a comprehensive final Read the Room score.

User flows in one embodiment include an Interviewer Signup Flow, an Interviewer Pre-Meeting Flow (where meeting goals and success criteria are input and a personalized talk track is generated), an Interviewer During-Meeting Flow (where live scores and dynamic coaching hints are displayed via a sidebar interface), and a Post-Meeting Flow (where performance data, meeting summaries, and follow-up plans are compiled). These flows ensure that the system continuously adapts its feedback and coaching in a manner that enhances overall conversational performance.

In summary, the present invention provides a comprehensive, real-time coaching system for improving conversational performance. By integrating multi-modal data capture, advanced preprocessing, dynamic analysis of conversation and emotional cues, and real-time coaching feedback, the system equips interviewers with actionable insights and suggestions to optimize their performance throughout the conversation.

### Examples

### 1. Job Interview

Steven is interviewing for a job with Bob. The interview is set to take place over a video meeting software. Steven has integrated a datastore with Nayak that includes several of his portfolio projects, some writing about his experiences, and his complete resume.

Ahead of the call, Steven enters the Nayak web application and views the talk track and pre-meeting notes Nayak has prepared for him. These notes include details about Bob's psychographic profile and the types of communication that resonate best with Bob. The talk track includes points Steven should talk about to make a positive impression on Bob, including pieces of information Nayak has gathered from the integrated datastore. The talk track is optimized for Bob's psychographic and cultural profile. For instance, Bob's DISC profile is the Editor, which means Bob prefers detailed information. The talk track reflects these preferences.

Steven makes a few changes to the talk track to reflect his personal speaking style and saves it.

At the time of the interview, Steven manually adds the Nayak Bot to the meeting by sharing the video meeting url with Nayak's system.

He sees the Read the Room score and uses Nayak's dynamic talk track to improve his performance in the interview. For instance, Nayak notices he is spending quite a bit of time talking about only one part of his resume and professional experience, and Nayak suggests Steven switch to another topic. When Nayak notices Bob is confused or disengaged, Steven is shown a hint on how to rephrase a point to better communicate with Bob or how to keep Bob engaged.

### 2. Investor Meeting

Janet is a startup CEO preparing to pitch Sarah, an investor. The meeting is set to take place over a video meeting software. Janet has integrated several systems with Nayak, including her CRM and document stores.

Ahead of the call, Janet views Nayak's prepared talk track and pre-meeting notes. The notes include up-to-date information on Sarah's latest investments, which are gathered and included using Nayak's web-scraping and data providers. The talk track is optimized for Sarah's profile, which is gathered using public data.

At the time of the interview, the Nayak Bot automatically joins the call because Janet is the meeting host and has integrated Nayak with her calendar.

Janet sees the Read the Room score and follows Nayak's hints and dynamic talk track to improve her performance in the conversation with Sarah. For instance, when talking about the detailed technical aspects of her company, Janet notices that Sarah is confused and Nayak prompts her with a hint: “Sarah is not very technical. Explain it again in general, simple terms.”

### 3. Sales Conversation

Sabrina is a sales rep preparing to pitch a potential customer, Dale, on an upcoming video call. Sabrina's company has integrated their CRM, data stores, and other systems with Nayak.

Sabrina enters Dale's company's information into Nayak, and Nayak prepares a talk track and pre-call notes optimized to Dale's profile and using information about Dale's company.

The Nayak Bot joins the call automatically.

Sabrina uses the real-time Read the Room score and dynamic talk track with hints to improve her performance. For instance, after asking a discovery question and getting a short reply that doesn't meet her success criteria, Nayak prompts her with a suggested follow-up question.

After the call, Sabrina's manager uses the final Read the Room score to gauge Sabrina's performance and to identify potential gaps in her skills to be used for future coaching opportunities.

### Embodiments

### Software (Video Meeting Software)

In this embodiment, there is a pre-call plan created. During the video meeting, which can be integrated with the meeting software manually or automatically via a calendar integration, the audio and visual data is sent to the Nayak software. The Nayak software then analyzes this data and displays the outputs, such as the “Read the Room” score and coaching suggestions, to the interviewer.

### Variations:

### Software (Note-Taking App Integration)

The pre-call plan is generated from an integration with an external note-taking app or an uploaded transcript from a previous call. This pre-call plan is then used when the meeting starts, which can be integrated with the meeting software manually or automatically via a calendar integration. The audio and visual data from the meeting is sent to the Nayak software, which analyzes it and displays the outputs to the interviewer.

### Software (Content Management System Integration)

In this variation, the pre-call plan is created, and the meeting is integrated with the meeting software manually or automatically via a calendar integration. The audio and visual data is sent to the Nayak software, which analyzes it and displays the outputs to the user. Additionally, the content management system acts as a source of data for hints and suggestions provided to the interviewer. The Nayak software also feeds back information to the content management system about which content was effective or ineffective during the meeting.

### Software (System of Record Integration)

The pre-call plan is created, and the meeting is integrated with the meeting software manually or automatically via a calendar integration. The audio and visual data is sent to the Nayak software, which analyzes it and displays the outputs to the interviewer. The Nayak software also records notes from the meeting in a system of record software, such as a CRM or case file, or any external system used to record meeting notes.

### Software (Phone Call, VOIP, or Contact Center)

### Phone Call or VOIP

In this embodiment, there is a talk track or pre-call plan. The audio stream from the phone call or VOIP is sent to the Nayak software, which analyzes it and displays the outputs, such as the “Read the Room” score and coaching suggestions, to the user.

### Contact Center

There is a talk track or pre-call plan. The audio stream from the contact center call is sent to the Nayak software, which analyzes it and displays the outputs to the interviewer. The Nayak software can also record the call data or notes in a system of record. After the call, the talk track is refreshed for the next call, and a new call is fetched from the call system.

### Audio/Visual Processing of In-Person Meetings

### Audio Recording

For in-person meetings, an audio recording is made and sent to the Nayak software, which analyzes it and displays the “Read the Room” score and next meeting plan to the user.

### Video Recording

Similar to the audio recording, but a video recording of the in-person meeting is made and sent to the Nayak software for analysis. The software then displays the “Read the Room” score and next meeting plan to the user based on the video data.

### Appendix

### Read the Room Score Algorithm

The Read the Room score is composed of three parts-a number value, a color (red, yellow, or green), and a determination of whether the goal was Met/Partially Met/Not Met.

Example Score: 85, Green, Met. This means the meeting went very well, the interviewee had a high level of understanding (low confusion), and the pre-set goal was met.

The score is fully defined below in the definitions section.

### Algorithms

Real-time Read the Room Score (RT): Calculated as RT=W(5F+2.5S+2.5A+5B) Where W is the baseline weight determined by personality, culture, and pre-meeting actions, F is facial expressions, S is voice sentiment, A is the alignment between facial expressions and sentiment, and B is body language. This weighted score reflects the overall emotional and engagement quality of the interaction.

Final Read the Room Score (FR): Calculated as FR=RT+W(5M+5Cam+12G+Conv), where M is assigned a value of 0 or 1 based on whether or not the participant was muted for the majority of the call, Cam is assigned a value of 0 or 1 based on whether or not the participant had their camera on for the majority of the call, G is assigned a value of 0, 0.5, or 1 based on whether or not the goal is met, partially met, or not met, and Conv is assigned a value based on criteria defined below. M, Cam, G, and Conv do not influence the Real-time Read the Room Score (RT).

### Inputs Ahead of the Meeting

Interviewer: What is the goal of the call? How will you know if you've achieved that goal? Examples: “The goal is to schedule a second call. I'll know I've succeeded if we have a second call on the calendar at the end of the meeting.”

Interviewee: Actions tracked (emails opened, emails replied to, meeting rescheduled, other team members invited). Personality mapped using public social profiles and a personality mapping data vendor such as Crystal Knows. Culture mapped using public social profiles and pieces of data such as country of origin, where they attended university, etc.

### Variables

Baseline Weight (W): Determined by personality type, culture, and actions taken prior to the meeting according to a set of pre-assigned scores. W is a number between 0.1 and 2. 0.1 would weigh all variables in the meeting more negatively. 2 would weigh all variables in the meeting more positively. Examples: Some personality types are more likely to demonstrate positive engagement regardless of a person's genuine feelings at the time. This factor would lower the baseline weight's score to accommodate this trait. Some cultures are more reserved in showing emotion through vocabulary or tone of voice—this would increase the baseline weight's score to accommodate that their voice sentiment might come across as negative regardless of the context. Rescheduling the meeting is a negative action. Opening emails or replying to emails is a positive action. Inviting team members from their org to the call is a positive action

Facial Expression Score (F): Assesses the count of positive and negative expressions, with adjustments based on the context of the conversation. Positive emotions generally increase the score, while negative emotions decrease it, with exceptions based on the sales context.

Voice Sentiment Score(S): Calculated by counting instances of positive and negative sentiments, where positive sentiments increase the score and negative sentiments decrease it.

Body Language Score (B): Counts instances of positive and negative body language cues. Positive cues increase the score, and negative cues decrease it, factoring into the overall assessment of the meeting's effectiveness.

Conversation Analytics (Conv): This includes the listen-to-talk ratio, the number of questions asked versus answered, and the frequency of interruptions. These metrics are used to adjust the final score based on the flow and dynamics of the conversation.

Real-Time and Final Score: The real-time score (RT) is calculated in real-time, during the call, followed by a final score that includes post-call analysis. The final score combines the real-time score with additional assessments on goals achieved, confusion levels, and conversation analytics for a comprehensive overview.

Confusion Score: Specifically looks at instances of confusion and engagement to adjust the score. Each instance of confusion increases the confusion metric, while engagement decreases it.

### Score Definitions

### Confusion Score

Color—Red=very confused, maps to a high number of instances of confusion and a low number of instances of engagement.

Yellow=Not very confused and not a very low level of understanding, maps to a medium number of instances of confusion and a medium number of instances of engagement.

Green=not confused at all, high level of understanding, maps to a low number of instances of confusion and a high number of instances of engagement.

### Numbers

0-30=meeting went very poorly
31-50=meeting went poorly
51-65=meeting went OK
65-80=meeting went well
81+=meeting went very well

### Goal Met/Partially Met/Not Met

Goal Met—The interviewer achieved their goal according to the criteria they set. Not Met—The interviewer did not achieve their goal.

Partially: The goal was discussed but the criteria was not achieved, or the interviewer/interviewee discussed plans to achieve the criteria after the call.

### Information Ranking Algorithm for Relevancy and Accuracy

The Information Ranking Score is composed of a numeric value.

Example Score: 85. This means the information source is highly accurate and relevant based on the calculated score.

### Algorithms:

Information Ranking Score (IR): Calculated as IR=5R+2.5S+2.5H+5E

Where:
R=Recency score
S=Source reputation score
H=Hedging language detection score
E=Endorsement/expertise score

This weighted score reflects the overall assessed accuracy and relevancy of the information source.

### Variable Definitions

Recency Score (R): Fresher data gets a higher recency score based on timestamp analysis.

Source Reputation Score(S): Calculated from factors like historical accuracy of the source, expertise level in the relevant domain, and explicit approvals.

Hedging Language Score (H): Natural language processing detects hedging/uncertain language. Higher detected hedging language lowers the confidence score.

Endorsement/Expertise Score (E): Incorporates implicit endorsement signals like citations, as well as an assessment of the source's expertise.

### Source Reputation Score(S):

Focuses on the historical accuracy and track record of the specific source providing the information

Considers the expertise level of that source in the relevant subject domain. May incorporate any explicit endorsements or approvals of that source

### Endorsement/Expertise Score (E):

Looks at implicit endorsement signals, like how often the source is cited or referenced by others

Provides an assessment of the source's expertise, possibly using factors beyond just the specific domain

Does not directly evaluate the source's historical accuracy, but implies accuracy through endorsements

### Score Definitions:

$$0 - 30 = Low accuracy / relevancy$$

13

$$31 - 65 = Medium accuracy / relevancy$$

$$66 += High accuracy / relevancy$$

The top-ranked information sources would be considered the most accurate and relevant based on the composite Information Ranking Score.

Additional refinements could include enhanced context awareness, corroborating evidence analysis, user feedback loops, and conflict resolution strategies . . .

What is claimed is:

1. A process for evaluating an ongoing conversation in real time, the process comprising:
characterizing the subject using a psychographic profile, a demographic profile job title, or company information;
converting speech to text;
diarising the text so as indicate which of the host or subject is talking;
analyzing subject's text and tone;
assigning a score to the conversation as a function of the characterization, the text and tone; and
modulating the score.

2. The process of claim 1, wherein evaluating the performance of the conversation in real time comprises:
analyzing video of the conversation participant to identify facial expressions; and adjusting the performance evaluation based on the identified facial expressions, wherein positive facial expressions improve the performance evaluation and negative facial expressions decrease the performance evaluation.

3. The process of claim 1, wherein evaluating the performance of the conversation in real time further comprises:
analyzing video of the conversation participant to identify body language; and adjusting the performance evaluation based on the identified body language, wherein positive body language improves the performance evaluation and negative body language decreases the performance evaluation.

4. The process of claim 1 further comprising:
tracking, during the conversation, whether the conversation participant is on mute or has their camera turned off; and
adjusting the performance evaluation based on the tracked mute and camera status, wherein being on mute or having the camera off for a significant portion of the conversation decreases the performance evaluation.

5. The process of claim 1, wherein the process further comprises:
determining, based on an analysis of the conversation content, whether a pre-defined goal for the conversation is discussed; and
adjusting the performance evaluation based on whether the goal is discussed, wherein discussing the goal improves the performance evaluation.

6. The process of claim 1, wherein evaluating the performance of the conversation in real time further comprises calculating conversation statistics selected from the group consisting of:
a ratio of speaking time between the conversation leader and the conversation participant;
a number of questions asked by the interviewer;
a number of questions asked by interviewee;
a number of interruptions by the interviewer; and
a number of interruptions by the interviewee; and wherein the performance evaluation is adjusted based on the calculated conversation statistics.

7. The process of claim 1, wherein a confusion score is determined by: analyzing video of the conversation participant to identify facial expressions; analyzing video of the conversation participant to identify body language; increasing the confusion score based on a number of instances of confusion identified from the facial expressions and body language; and
decreasing the confusion score based on a number of instances of engagement identified from the facial expressions and body language.

8. The process of claim 1, wherein the confusion score is mapped to a color, the color selected from the group consisting of:
red, indicating a high level of confusion;
yellow, indicating a medium level of confusion; and
green, indicating a low level of confusion.

9. The process of claim 1, wherein modulating the score based on the confusion score includes:
decreasing the score in proportion to the confusion score if the confusion score indicates a high level of confusion; and
increasing the score in proportion to an engagement score if the confusion score indicates a low level of confusion.

10. The process of claim 1, further comprising:
determining, at the end of the conversation, a final confusion score based on facial expressions and body language analyzed throughout the entirety of the conversation; and updating the modulated score to incorporate the final confusion score in addition to the real-time confusion score.

11. A system for providing real-time coaching to improve the performance of a conversation, the system comprising:
a data collection module configured to receive audio, video, or input data for the conversation in real-time, the input data selected from the group consisting of: a psychographic profile, a demographic profile, a job title, and company information of a conversation participant;
a conversation analysis module configured to evaluate the performance of the conversation in real-time according to the method of claim 1, including:
converting speech to text and diarizing to identify which party is speaking,
analyzing the language used and tone of voice of the conversation participant,
analyzing video to identify facial expressions and body language,
tracking actions during the conversation such as mute/camera status and discussion of pre-defined goals, and
calculating conversation statistics; and
a coaching module configured to provide real-time suggestions for improving conversation performance based on the real-time performance evaluation.

12. The system of claim 11, wherein the conversation analysis module is further configured to:
assign a score evaluating the performance of the conversation based on the real-time analysis; and
categorize the conversation as one of good performance, neutral performance or bad performance based on the assigned score.

13. The system of claim 11, wherein the conversation analysis module is further configured to modulate the assigned score based on the facial expressions, body language, mute/camera status, discussion of goals, and conversation statistics analyzed during the conversation.

14. The system of claim 11, wherein the coaching module is configured to provide the real time suggestions at a plurality of timepoints during the conversation, the suggestions adapted based on tracking changes in the real-time performance evaluation.

15. The system of claim 11, wherein the coaching module is further configured to:
identify one or more areas of improvement based on the real-time performance evaluation; and
provide targeted coaching suggestions focused on the identified areas.

16. The system of claim 11, wherein the coaching module is further configured to guide the conversation towards achieving the pre-defined goals for the conversation based on the real-time analysis of conversation content.

17. A system for ranking information from data sources for relevance and accuracy in real-time, the system comprising:
a data aggregation module configured to collect information from a plurality of data sources, the data sources selected from the group consisting of: databases, data systems, software operations, and web crawlers/knowledge graphs;
an information ranking module configured to:
assign a recency score to each piece of information based on a timestamp or date of creation/update, —assign a source reputation score to each data source based on factors including historical accuracy, expertise level in the relevant domain, and endorsements/approvals,
detect the presence of hedging or cautious language in each piece of information and assign a hedging language score based on the degree of hedging language detected,
assign an endorsement/expertise score to each data source based on implicit endorsement signals and an assessment of the source's expertise, and calculate an Information Ranking Score for each piece of information by combining the recency score, source reputation score, hedging language score, and endorsement/expertise score using a weighted sum; and
a display module configured to display the collected information to a user in order of the Information Ranking Scores.

18. The system of claim 3, wherein the data aggregation module is further configured to continuously collect information from the data sources in real-time and update the Information Ranking Scores based on newly collected information.

19. The system of claim 17, wherein the information ranking module is further configured to:
assign the recency score on a scale from 0 to 1, with more recent information receiving a higher recency score,
assign the source reputation score on a scale from 0 to 1, with higher reputation sources receiving a higher score,
assign the hedging language score on a scale from 0 to 1, with information containing more hedging language receiving a lower score, and
assign the endorsement/expertise score on a scale from 0 to 1, with higher endorsed or expert sources receiving a higher score.

20. The system of claim 17, wherein the information ranking module is further configured to categorize each piece of information as high, medium or low accuracy/relevancy based on its Information Ranking Score falling into predefined ranges.

21. The system of claim 17, wherein the information ranking module is further configured to incorporate user feedback on the relevance and accuracy of the ranked information to adaptively adjust the weights in the Information Ranking Score calculation.

22. The system of claim 17, wherein the information ranking module is further configured to analyze the collected information for corroborating evidence from multiple sources and increase the Information Ranking Score for information pieces with corroboration.

23. The system of claim 17, wherein the information ranking module is further configured to implement conflict resolution strategies when collected information contains contradictions, the conflict resolution strategies selected from the group consisting of: evaluating source reputation scores, evaluating recency scores, and incorporating human oversight.
